(19) United States
(12) Patent Application Publication
(10) Pub. No.: US 2004/0215812 A1
(43) Pub. Date: Oct. 28, 2004

(54) Packet-drop tolerant method for transmitting time-critical data over ethernet

(76) Inventor: Kai Lu, Skokie, IL (US)

Correspondence Address: Kai Lu, 4320 Grove St., Skokie, IL, 60076, US

(21) Appl. No.: 09/835,310

(22) Filed: Apr. 16, 2001

(51) Int. Cl. G06F 15/16

(52) U.S. Cl. 709/233; 709/251

(57) ABSTRACT

A method for transmitting the time-critical data over Ethernet. The method can tolerate at least 50% of packet-drop without affecting the quality of transmission. Ethernet network is considered a connectionless network, so the packet-drop is not avoidable. Therefore, the key to transmitting the time-critical data over Ethernet is not to prevent the packet-drop, but to control and to tolerate the packet-drop. To tolerate the packet-drop, we have to carry redundant data in each Ethernet packet so that we can recover the lost information from the redundant data when packet-drop occurs. An easy way of carrying the redundant data is as follows. Every packet carries two parts of data. The first part is the required data, and the second part is the redundant data. The required data is the data that the packet is supposed to carry in the case without redundant data. The redundant data is the required data of the next packet. When a packet is dropped, we can use the redundant data of the previous packet to recover the lost information. To be able to recover all the lost information, we need to control the packet-drop. In other words, when congestion happens, we should actively and selectively drop the packets to prevent random and bursty packet-drop so that the redundant data can be used to recover all the lost information. Based on the redundant data we are carrying, one way of controlling the packet-drop is as follows. When congestion happens, we drop all the even-number packets, and all the lost information can be recovered from all the odd-number packets' redundant data. This is a 50% of traffic reduction, and we don't affect the quality of transmission at all.

It looks like we doubled the Ethernet traffic by carrying the redundant data. But our calculations show that, in our example, for a 50% of packet-drop tolerance, we only increase 10% of the Ethernet traffic when we use RTP. If we use cRTP, we won't increase the Ethernet traffic at all; this means we get 50% of packet-drop tolerance for free when using CRTP.

The method doesn't require any physical or wiring changes to the existing Ethernet. The transmission of the regular best-effort data will be the same as the standard Ethernet. Finally, it's a software only solution and easy to implement.

### FIELD OF INVENTION

This invention relates generally to the field of computer networks and VoIP (Voice over IP Networks), and more particularly to the field of voice over Ethernet or multimedia over Ethernet.

### BACKGROUND OF INVENTION

Ethernet technology is ubiquitous. More than 85% of all installed network connections were Ethernet. Highly reliable networks are critical to today's enterprises. Ease of installation and support are the primary considerations in the choice of network technology [1]. Today, Ethernet networks are rapidly approaching the reliable level associated with their telephone ancestors, and are relatively simple to understand and administer. The ability to transmit the time-critical information over Ethernet networks will drive the next boom in network technology and business.

Ethernet was originally designed for transmitting regular data [1], such as file transfer and email; we call this type of data the best-effort data. Nowadays, more and more applications generate and transmit a new type of data, such as voice and multimedia data over IP (Internet Protocol) networks. We call this type of data the time-critical data. The key difference between these two types of data is that the best-effort data can tolerate delay, but the time-critical data cannot. For the best-effort data, packet-drop is not a problem, because the best-effort data can tolerate delay, and we can always retransmit the dropped packet later. But for the time-critical data, the situation is totally different. Since the time-critical data cannot tolerate delay, the retransmission of dropped packets is not relevant. Therefore, the dropped packets are lost forever for the time-critical data.

Ethernet protocol is considered a connectionless protocol. In a connectionless network, such as Ethernet, congestion is not avoidable. This means that some packets may be dropped or delayed, and some packets may be delivered out of sequence when congestion happens. Therefore, the quality of service (QoS) is not guaranteed in a connectionless network such as Ethernet. Ethernet is suitable to the best-effort data because the best-effort data can tolerate those problems, and the upper level protocols will correct those problems. However, the time-critical data will not tolerate those problems. When packets are dropped or delayed, the quality of the time-critical data transmission will be degraded. Therefore, the current Ethernet protocol is not suitable for transmitting the time-critical data, such as voice and multimedia data. The present invention solves this problem.

An Ethernet packet consists of 6 bytes of destination address, 6 bytes of source address, 2 bytes of type field, a data field of variable length and 4 bytes of CRC (Cyclic Redundancy Check) field [1], see FIG. 1. Based on the IEEE802.3 standard, the minimum packet length is 64 bytes and the maximum packet length is 1518 bytes. Since there are 6 bytes of destination address, 6 bytes of source address, 2 bytes of type and 4 bytes of CRC, the length of the data field is between 46 and 1500 bytes.

In order to transmit packet-by-packet correctly, Ethernet stations need to send a special 8-byte field called Preamble in the front of every packet. In addition, a 12-byte Inter Frame Gap (IFG) between any two packets is also required by the Ethernet protocol. FIG. 2 shows what an Ethernet packet really looks like. So a minimum-length Ethernet packet will take 64+8+12=84 bytes of time slot, and a maximum-length Ethernet packet will take 1538 bytes of time slot to transmit.

When we transmit IP (Internet Protocol) data over Ethernet networks, inside the data field of an Ethernet packet, there will be an IP packet [2]. An IP packet includes a 20-byte header followed by a data field of variable length, see FIG. 3.

When we transmit the time-critical data over IP networks, inside the data field of an IP packet, there will be an UDP (User Datagram Protocol) packet [2]. An UDP packet includes 8 bytes of header followed by a data field of variable length, see FIG. 4. And inside the data field of an UDP packet, there will be an RTP (Real-time Transport Protocol) packet [2]. An RTP packet includes 12 bytes of header followed by a data field of variable length, see FIG. 5. FIG. 6 shows what a complete Ethernet packet with the time-critical data will look like.

From FIG. 6, we can see that every Ethernet packet has 8 bytes of Preamble, 14 bytes of Ethernet header, 20 bytes of IP header, 8 bytes of UDP header, 12 bytes of RTP header, 4 bytes of Ethernet CRC and 12 bytes of IFG. These are a total of 78 bytes of overhead in each Ethernet packet. Now let's use Cisco's VoIP product as an example to see how many bytes of the time-critical data will be carried inside the data field of each packet.

In the Cisco IOS VoIP product, the Digital Signal Processor (DSP) generates a speech packet every 10 ms (milliseconds) when using G.729 [2]. The G.729 codec algorithm generates 8 kb (kilobits) of data every second. So, for 10 ms of voice, the G.729 algorithm will generate 80 bits, or 10 bytes (1 byte=8 bits) of data. If we transmit 10 ms of voice in every Ethernet packet, the data field will carry only 10 bytes of data and the total packet length will be 88 bytes. So, in an 88-byte Ethernet packet, the real data only takes 10 bytes, or 11%. In other words, every Ethernet packet carries 89% of overhead if we transmit 10 ms of voice in every Ethernet packet. If we transmit 20 ms of voice in each packet, every Ethernet packet will still carry 80% of overhead.

A new protocol called cRTP (compressed RTP) can be used to improve the efficiency of the time-critical data transmission [2]. When we use cRTP, the 12 bytes of RTP header, 20 bytes of IP header and 8 bytes of UDP header can be compressed into a new header of 2-4 bytes. If we use cRTP, the Ethernet packet of FIG. 6 will have the packet format as shown in FIG. 7.

Remember that the minimum packet length of an Ethernet packet is 64 bytes, without counting the Preamble and IFG [1]. When we use cRTP, this limitation will restrict the data field of a cRTP packet to the length at lest 64−18−4=42 bytes. Therefore, if the time-critical data is less than 42 bytes, then we have to fill in with pad data to make it meet the minimum length requirement [1]. The pad data is another overhead of the Ethernet packet. Using Cisco IOS VoIP product as an example, if we transmit 10 ms of voice in every packet, which is 10 bytes of voice data in one packet, we need to fill 32 bytes of pad data in each packet. Even if we transmit 20 ms of voice in every packet, which is 20 bytes of voice data in one packet, we still need to fill 22 bytes of pad data in each packet. That means the pad data is always required when we use cRTP.

Ethernet is the most popular LAN (Local Area Network) in the world [1]. It connects almost every desktop of an enterprise. Any information that needs to go to a desktop has to go through the Ethernet first. Therefore, if we want to transmit the time-critical data over IP networks, we have to be able to transmit the time-critical data over Ethernet. Transmitting the time-critical data over Ethernet is not a difficult task. However, the quality of transmitting the time-critical data over Ethernet is not guaranteed because of the connectionless nature of the Ethernet protocol. Today, there is no practical way to ensure the quality of transmitting the time-critical data over Ethernet. Ensuring the quality of service is the key to the success of transmitting the time-critical data over Ethernet, and the present invention solves this problem.

### BACKGROUND—DISCUSSION OF PRIOR ART

There are 8 U.S. patents related to Ethernet and voice. U.S. Pat. No. 6,175,562: Switchless call processing, issued Jan. 16, 2001; this invention provides a switchless Automatic Call Distribution (“ACD”) system distributing incoming calls to call agents networked via a low-cost data network such as an ethernet. U.S. Pat. No. 6,173,044: Multipoint simultaneous voice and data services using a media splitter gateway architecture, issued Jan. 9, 2001; this invention provides a gateway that enables point to multipoint connectivity from voice, data, or SVD clients over voice and data networks. U.S. Pat. No. 6,161,134: Method, apparatus and communications system for companion information and network appliances, issued Dec. 12, 2000; this invention provides an information appliance and a network appliance (or telephone) that function independently as well as with each other as companion appliances. U.S. Pat. No. 6,122,359: System for coordinating calls between an adjunct device and a switching system, issued Sep. 19, 2000. U.S. Pat. No. 5,974,056: Method and apparatus for transmission of data, issued Oct. 26, 1999; this invention provides a method and apparatus for transmission of data for voice, signaling data, air traffic control facilities, telephone equipment, communication systems, etc. U.S. Pat. No. 5,841,778: System for adaptive backoff mechanisms in CSMA/CD networks, issued Nov. 24, 1998; this invention provides a system for controlling traffic on a contention-based local area network (LAN) such as one according to the CSMA/CD or Ethernet. U.S. Pat. No. 5,553,071: Communication system topology providing dynamic allocation of B-channels, issued Sep. 3, 1996; in this invention, communications systems and methods are directed to a novel communications platform which employs a TDM bus, a TDM bus controller, a passive Ethernet bus, and a centralized Ethernet hub to provide for the communication of data, voice, and/or video signals among a plurality of endpoint devices. U.S. Pat. No. 4,766,591: Random multiple-access communication system, issued Aug. 23, 1988; this invention provides a random multiple-access communication system, which operates both a feedback-ignored (e.g. ETHERNET) and a feedback-utilized (e.g. STACK) protocol simultaneously.

There are 6 U.S. patents related to Ethernet and multimedia. U.S. Pat. No. 6,091,725: Method for traffic management, traffic prioritization, access control, and packet forwarding in a datagram computer network, issued Jul. 18, 2000; the invention provides an enhanced datagram packet switched computer network. U.S. Pat. No. 6,026,095: Method and apparatus for controlling latency and jitter in shared CSMA/CD (repeater) environment, issued Feb. 15, 2000; this invention provides an improved computer network and network device uses characteristics of prior art shared network protocols to control the flow of data and access to the network among a group of transmitting nodes. U.S. Pat. No. 5,930,238: Asynchronous transfer mode (ATM) multicast tree delivery switching, issued Jul. 27, 1999; this invention provides multimedia multipoint conferencing and distance learning sessions utilizing the ATM network use multimedia conferencing equipment at remote sites coupled to the ATM network via ATM network interface switches. U.S. Pat. No. 5,852,723: Method and apparatus for prioritizing traffic in half-duplex networks, issued Dec. 22, 1998; in this invention, collision delay intervals are modified in Ethernet network devices transmitting priority data requiring a guaranteed latency by multiplying an integer multiple number of slot times with a fractional coefficient. U.S. Pat. No. 5,822,538: Method and apparatus for prioritizing traffic in half-duplex networks by selecting delay intervals from fixed ranges, issued Oct. 13, 1998; in this invention, collision delay intervals are modified in Ethernet network devices by transmitting priority data requiring a guaranteed latency by determining an integer multiple number of slot times, randomly selected from a predetermined range of integers, where the range of integers is independent from the number of access attempts. U.S. Pat. No. 5,680,392: Multimedia multipoint telecommunications reservation systems, Oct. 21, 1997; in this invention, reservation controllers and reservation systems for reservation of access to multimedia multipoint telecommunications servers (MCUs) are provided.

None of the patents above is intended to transmit the time-critical data over the existing Ethernet by controlling and tolerating the packet-drop to ensure the quality of transmission. My invention is different from all the patents above because I do not want to change the existing Ethernet or to invent a new type of network protocol. My invention is intended to provide an easy way to control and tolerate the packet-drop so that we can transmit the time-critical data, such as voice and multimedia data, over existing Ethernet.

### OBJECTS AND ADVANTAGES

Accordingly, the major object and advantage of the present invention is to provide a simple method for transmitting the time-critical data over Ethernet. The method can tolerate at least 50% of packet-drop without affecting the quality of transmission. Another big advantage is that no change is required to the existing Ethernet.

### DESCRIPTION OF THE DRAWINGS

FIG. 1 shows the basic Ethernet packet format, which includes 6 bytes of destination address, 6 bytes of source address, 2 bytes of type field, a data field of variable length and 4 bytes of CRC (Cyclic Redundancy Check) field.

FIG. 2 shows the complete Ethernet packet format with Preamble and IFG.

FIG. 3 shows the IP packet format, which includes a 20-byte header followed by a data field of variable length.

FIG. 4 shows the UDP packet format, which includes 8 bytes of header followed by a data field of variable length.

FIG. 5 shows the RTP packet format, which includes 12 bytes of header followed by a data field of variable length.

FIG. 6 shows a complete Ethernet packet with all the upper-level protocol headers for transmitting the time-critical data.

FIG. 7 shows an Ethernet packet when using cRTP, where the 12 bytes of RTP header, 20 bytes of IP header and 8 bytes of UDP header are compressed into a cRTP header of 2-4 bytes.

FIG. 8 shows the continuous voice data carried in corresponding RTP packets, where D1 is the data field of packet 1 and Dn is the data field of packet n.

FIG. 9 shows the data field of RTP packets with required and redundant data, where D1 is the data field of packet 1, Dn is the data field of packet n, req is the required data and red is the redundant data.

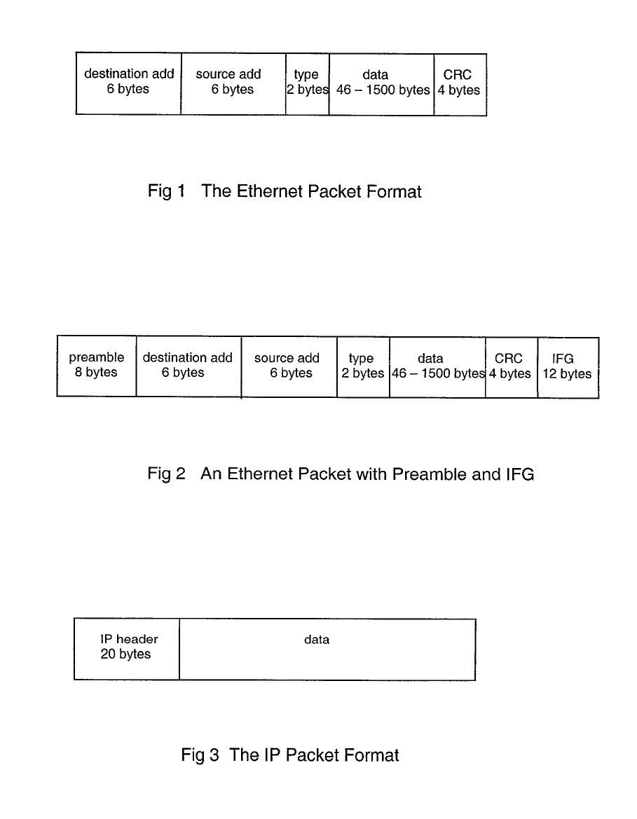

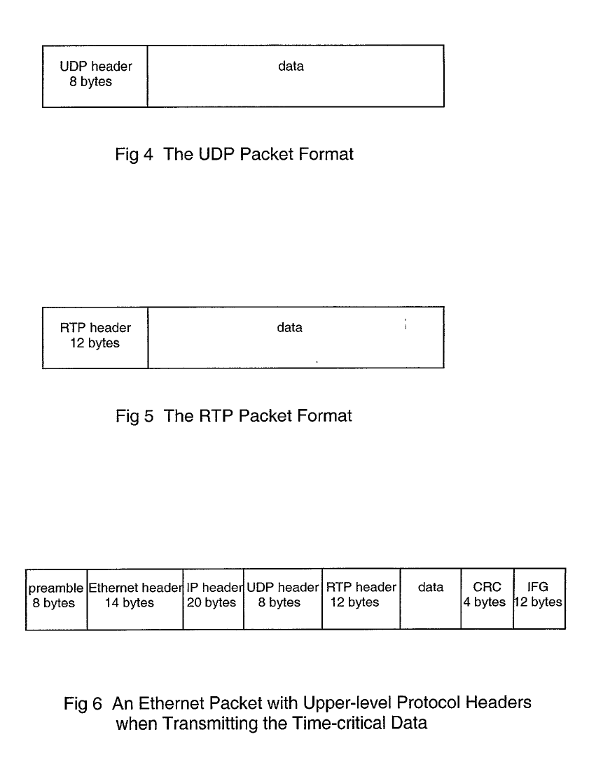

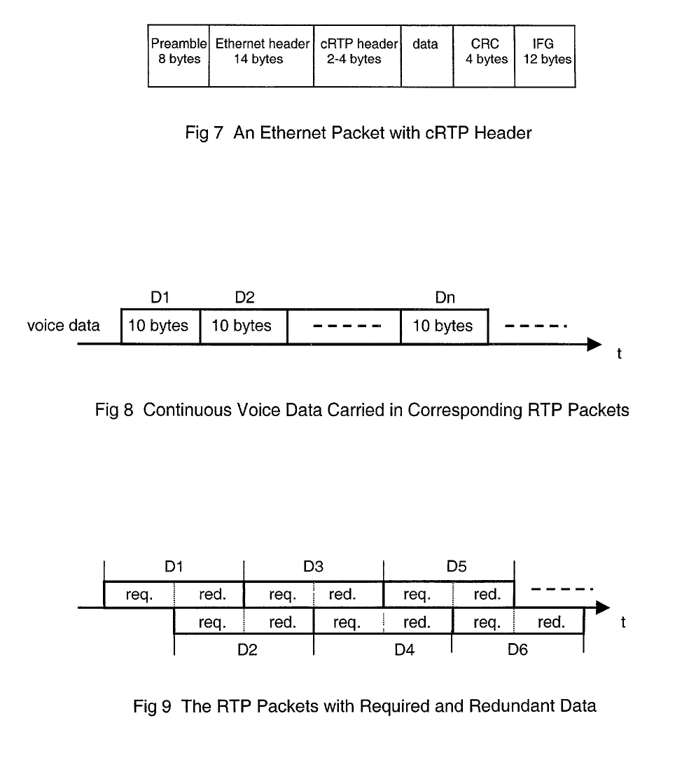

### SUMMARY

In accordance with the present invention, a packet-drop tolerant method for transmitting the time-critical data over Ethernet networks is provided.

Ethernet is the most popular LAN in the world. It connects almost every desktop of a company. All the data that needs to go to a desktop has to go through the Ethernet. Because of the connectionless nature of the Ethernet protocol, traffic congestion is not avoidable in an Ethernet network. When congestion occurs, packet-drop will happen, and the time-critical data cannot tolerate the packet-drop. So, the key to successful transmitting the time-critical data over Ethernet is not to avoid the packet-drop, but to control and tolerate the packet-drop. Therefore, we need a method to prevent random and bursty packet-drop to the time-critical data and to tolerate the packet-drop when we have to drop packets. The present invention provides a simple method for transmitting the time-critical data over Ethernet, which can tolerate at least 50% of the packet-drop for time-critical data without affecting the quality of its transmission.

To be able to tolerate the packet-drop, we have to carry some redundant data inside each Ethernet packet. Therefore, when some packets are dropped, we can recover the lost information from the redundant data. Now, how do we carry the redundant data, and what redundant information do we need to carry inside each Ethernet packet? To illustrate the method, we use Cisco IOS VoIP product as an example, but this method could be used for transmitting any time-critical data over Ethernet.

In our illustration, we assume that each Ethernet packet carries 10 ms of voice, which are 10 bytes of data [2]. In the case without carrying redundant data, we would include the 10 bytes of voice data in the data field of each RTP packet; one packet after another without any overlapping or gaps as shown in FIG. 8, where D1 is the data field of packet 1 and Dn is the data field of packet n.

Now we want to carry the redundant data in each packet so that we can tolerate the packet-drop. To illustrate the method, I am going to describe one way of carrying the redundant data in each packet, and it will tolerate 50% of packet-drop. We assumed that each packet carries 10 ms of voice (10 bytes of data); this is the required data that each packet has to carry in the case without the redundant data. Besides the required data, every packet carries the redundant data that is the required data of the next packet (another 10 bytes of data in this illustration), see FIG. 9, where D1 is the data field of packet 1, Dn is the data field of packet n, req is the required data and red is the redundant data.

Now every packet carries the redundant data, which is the required data of the next packet. In the case of no packet-drop, only the required data of each packet will be used, and the redundant data will be discarded. Whenever a packet is dropped or a packet didn't show up by the time it supposed to, the redundant data of the previously received packet would be used as if the packet was received, so that the quality of transmission is not affected at all.

However, if two or more adjacent packets are dropped, we cannot recover all the lost information. Therefore, the key point is to control the packet-drop to prevent random and bursty packet-drop. When congestion happens, based on the redundant data we are carrying, to prevent random and bursty packet-drop, we should actively and selectively drop all the even-number packets (or all the odd-number packets). This is a 50% of traffic reduction, and we don't affect the quality of transmission at all because we can recover all the lost information from the redundant data.

The method described above can tolerate 50% of packet-drop, and at the same time it increases the voice data by 100% in each packet. But the overall traffic increase is significantly less or negligible. Recall that when we use RTP, without carrying the redundant data, the total Ethernet packet length is 88 bytes. After we add 10 bytes of redundant data, the total Ethernet packet length will be 98 bytes. So the 10 bytes of the redundant data are only 10% of the total Ethernet packet length. Therefore, if we use RTP, we get 50% of packet-drop tolerance with only 10% of Ethernet traffic increase. If we use cRTP, without carrying the redundant data, the Ethernet packet length is 84 bytes (after fill in the pad data to meet the minimum packet length requirement). After we add 10 bytes of redundant data the packet length will be still 84 bytes (we still need to fill in some pad data). Therefore, if we use cRTP, we get 50% of packet-drop tolerance without increasing the Ethernet traffic at all.

Since we need to carry the redundant data, which is the required data of the next packet, this method introduces a small time delay that is equal to one packet transmission time, which is 10 ms in our example. The International Telecommunication Union Telecommunication Standardization Sector (ITU-T) G. 114 recommendation specifies that, for good voice quality, no more than 150 ms of one-way, end-to-end delay should occur [2]. Therefore, the 10 ms of time delay is negligible in voice transmissions.

The method described above can tolerate 50% of packet-drop by carrying the proper redundant data, which is the required data of the next packet. This method can be easily extended to tolerate more packet drops. For example, if each packet carries the redundant data, which is the required data of the next two packets, then we can tolerate up to 66.7% of the packet-drop without affecting the quality of transmission. In a well designed network, when congestion happens, we should be able to resolve the congestion by reducing the traffic by 50 or 66 percent.

The method described above will not affect the transmission of regular best-effort data; its transmission will be the same as the standard Ethernet. The method does not require any physical or wiring changes to the existing Ethernet.

### CONCLUSION, RAMIFICATIONS, AND SCOPE OF INVENTION

Thus, those skilled in the art will appreciate that the present invention provides an easy way to transmit the time-critical data over Ethernet networks, which can tolerate at least 50% of packet-drop with only 0 or 10% of Ethernet traffic increase (depends on which protocol is used, cRTP or RTP). Since the Ethernet network is considered a connectionless network, the packet-drop is not avoidable. Therefore, the present method is not trying to avoid the packet-drop. On the contrary, the method is trying to control and to tolerate the packet-drop. By carrying the redundant data, we can tolerate the packet-drop. By actively and selectively dropping packets, we can control the packet-drop to avoid random and bursty packet-drop, so that we can recover all the lost information from the redundant data.

This method introduces a small time delay, which is one packet transmission time (10 ms in our example). It does not require any physical or wiring changes to the existing Ethernet. The regular best-effort data transmission will not be affected by transmitting the time-critical data using this method because the overall traffic overhead introduced by this method is negligible. Finally, it's a software only solution and easy to implement.

While my description above contains specificities, these should not be construed as limitations on the scope of the invention, but rather as an exemplification of one preferred embodiment thereof. Many other variations are possible. For example, this method could be used to transmit real-time video information or any other time-critical messages over connectionless packet-switched networks.

Accordingly, the scope of the invention should be determined not by embodiment illustrated, but by the appended claims and their legal equivalents.

I claim:

1. A method for transmitting the time-critical data over Ethernet networks; the method comprising:
A scheme of carrying the redundant data in each packet, which can be used to recover the lost information when a packet is dropped;
A strategy of actively and selectively dropping packets when congestion happens to resolve the traffic congestion, the lost information will be able to recovered from the redundant data; and
A means of recovering the lost information when packet-drop happens, so that the quality of transmission will not be affected.

2. The method of claim 1, wherein said the scheme of carrying the redundant data in each packet can be done as follows. The data carried in each packet is composed of two parts: the required data and the redundant data. The required data is the data that the packet supposes to carry in the case without redundant data. The redundant data is the required data of the next packet. So that if the next packet is dropped we can recover the lost information from the redundant data of this packet.

3. The method of claim 1, wherein said the strategy of actively and selectively dropping packets when congestion happens can be done as follows. When congestion happens, we drop all the even-number packets. All the lost data can be recovered from all the odd-number packets' redundant data.

4. The method of claim 1, wherein said the strategy of actively and selectively dropping packets when congestion happens can be done as follows. When congestion happens, we drop all the odd-number packets. All the lost data can be recovered from all the even-number packets' redundant data.

5. The method of claim 1, wherein said the means of recovering the lost data when packet-drop happens can be accomplished as follows. When a packet arrives, we use the required data and save the redundant data. If the next packet is dropped, we use the saved redundant data as if the next packet was received. If the next packet arrives, we discard the saved redundant data.

6. A method for transmitting the time-critical data over packet-switched networks; the method comprising:
A scheme of carrying the redundant data in each packet, which can be used to recover the lost information when a packet is dropped;
A strategy of actively and selectively dropping packets when congestion happens to resolve the traffic congestion, the lost information will be able to recovered from the redundant data; and
A means of recovering the lost data when packet-drop happens, so that the quality of transmission will not be affected.

7. The method of claim 6, wherein said the scheme of carrying the redundant data in each packet can be done as follows. The data carried in each packet is composed of two parts: the required data and the redundant data. The required data is the data that the packet supposes to carry in the case without redundant data. The redundant data is the required data of the next N packets, where N=1, 2, 3 . . . . So that if any of the next N packets are dropped we can recover the lost data from the redundant data of the received packet.

8. The method of claim 6, wherein said the strategy of actively and selectively dropping packets when congestion happens can be done as follows. When congestion happens, we keep one packet and drop N packets that follow the kept packet, where N=1, 2, 3 . . . . All the lost data can be recovered from the redundant data of the kept packet.

9. The method of claim 6, wherein said the means of recovering the lost data when packet-drop happens can be accomplished as follows. When a packet arrives, we use the required data and save the redundant data. If the next i packets are dropped, we will use the first i parts of the redundant data of the received packet to recover the lost data, where i=1, 2, . . . N. If no packet is dropped, we only use the required data and discard the saved redundant data.
